(19) United States
(12) Patent Application Publication
(10) Pub. No.: US 2021/0304303 A1
(43) Pub. Date: Sep. 30, 2021

(54) System and Method for Efficient Allocation of Resources in a Financial Services Branch

(71) Applicant: Cash Flow Management, Inc., Chandler, AZ (US)

(72) Inventors: Nathan Moore, Scottsdale, AZ (US); John Dillon, Gilbert, AZ (US); Jim Ransco, II, Paradise Valley, AZ (US); Jianing Chen, Chandler, AZ (US)

(73) Assignee: Cash Flow Management, Inc., Chandler, AZ (US)

(21) Appl. No.: 17/230,777

(22) Filed: Apr. 14, 2021

Related U.S. Application Data
(63) Continuation of application No. 14/065,355, filed on Oct. 28, 2013, now abandoned.

(51) Int. Cl. G06Q 40/02

(52) U.S. Cl. CPC G06Q 40/02

(57) ABSTRACT

A system for efficient allocation of resources in a financial services branch includes a branch computer system and a remote solutions server which are in communication with a core banking server. The branch computer system includes various computer, network devices and equipment for branch operations. A plurality of customer devices, such as smartphones and tablet computers, can be connected to a remote solutions server. Each such device can be pre-configured with a remote banking application (“app”) allowing a respective customer to use the device to communicate with the remote solutions server to perform the remote banking. The remote solutions server facilitates remote banking wherein transactions can be completed using in-branch banking equipment. Additionally, the banking customer may schedule time with banking personnel using this application, wherein the meeting can take place at the same branch where the transaction will be completed.

### BACKGROUND OF THE INVENTION

### 1. Field of the Invention

The present invention relates to the efficient allocation of resources in a financial services branch.

### 2. Description of the Related Art

Banks and credit unions are constantly looking for ways to reduce the time their staff spend on routine transactions and increase the time they spend on engaging with, relating to, teaching and providing products to their customers and members. For example, if a customer walks into a branch to cash a check, a teller must engage a computer, a check scanner and his or her drawer of currency to satisfy the transaction. This is time consuming, and with the teller completely focused on data entry and counting currency, there is little room for a conversation and possible sales opportunity with the customer.

Tellers must perform transactions seamlessly and balance their teller drawer or they will lose their job. That is a simple fact within this industry. Tracking the cash they are responsible for comes first and customer relations come second in a teller's world. Automation of these processes, especially the cash portion, has made a positive impact in this regard. It has helped the teller focus more on the customer and less on the cash as the automation is handling the counting, tracking and balancing for them. At the same time, technology has empowered customers to be able to do many routine tasks that used to require a visit to the branch.

### SUMMARY OF THE INVENTION

One aspect of the disclosure relates to a method for efficient allocation of resources in a financial services branch, comprising: (a) requesting use of a specified financial services resource within the branch; (b) placing a request for the financial services resource in a request table; (c) receiving an authentication token useable to satisfy the request; (d) presenting the authentication token to authenticate the use of the financial services resource; and (e) providing access, in the branch, to the financial services resource, if use of the financial services resource is authenticated and the request is found in the request table. In an embodiment, the authentication token can be machine-readable, such as a 2D bar code which can be displayed on a mobile device such as a smartphone or printed on paper for later presentation. Examples of financial services resources include, but are not limited to, a cash handling device, a check scanner, a self-service kiosk, and a teller station. Such financial services resources can be shareable by a plurality of tellers, other financial services personnel within the branch, and customers, and do not have to be situated at or near teller stations.

The financial services resource can be requested responsive to an in-branch banking application transaction (e.g., using a teller application) or a remote banking application transaction. In the latter case, at a remote location, the method further includes the customer performing a remote banking application to begin the transaction, the transaction to be completed in the branch at least in part using the requested financial services resource. The remote banking application can be performed by executing a banking application on a user device, such as a smartphone, a tablet computer, a laptop computer, or a desktop computer, etc. The remote banking application interacts with a remote solution server allowing a request for a financial services resource to be placed in the request table and the transaction completed in the branch using the requested financial services resource, upon presentation of the provided authentication token. In turn, the application executing on the remote solution server interacts with a core financial platform which actually accesses a customer account, performs the necessary transactions, and posts the transactions. The core financial platform can also be accessed by teller workstations to effect financial services transactions.

Additionally, in various embodiments of the present invention, using the remote banking application, the customer may schedule an appointment with banking personnel to discuss a matter of concern. For example, a commercial customer may wish to deposit cash and coins at a branch and, during the same visit, discuss with his or her personal banker an application for a business line of credit or loan. As another example, a banking customer may be in need of a mortgage, and using the remote banking application, schedule a meeting with a banking representative while also cashing a payroll check during the same visit. In these scenarios, the allocated resources can include the equipment (e.g., check scanner, cash dispenser) necessary to effect the transaction(s) and a scheduled meeting with the appropriate banking personnel.

Another aspect of the invention relates to a system for efficient allocation of resources in a financial services branch, comprising: a computer system configured to (a) receive a request for use of a specified financial services resource within the branch; (b) place a request for the financial services resource in a queue; and (c) provide access, in the branch, to the financial services resource, when the request is available in the queue.

Yet another aspect of the invention relates to a physical non-transitory computer readable medium comprising computer executable instructions stored on the physical non-transitory computer-readable medium that when executed by one or more computer processor cause the one or more processor to perform the following method steps disclosed herein.

### BRIEF DESCRIPTION OF THE DRAWINGS

FIG. 1 illustrates an exemplary system for efficient allocation of resources in a financial services branch, according to an embodiment of the present invention;

FIG. 2 illustrates use of the system of FIG. 1 for a transaction initiated using a remote banking application and completed at the branch;

FIG. 3 illustrates use of the system of FIG. 1 for a transaction initiated using a teller application in a branch and completed at the branch according to an embodiment of the present invention;

FIG. 4 illustrates an exemplary self-service arrangement for cashier's check printing and endorsement, used in conjunction with the present invention according to an embodiment of the present invention; and

FIG. 5 illustrates an exemplary ecommerce system for in which a financial transaction is initiated using a remote banking application and completed at a retail location, according to another embodiment of the present invention.

### DETAILED DESCRIPTION OF THE INVENTION

A system for efficient allocation of resources in a financial services branch includes a branch computer system 150 and a remote solutions server 104 which are in communication with a core banking server 120. The branch computer system 150 includes various computer, network devices and equipment for branch operations. A plurality of customer devices 110, such as smartphones and tablet computers, can be connected to the remote solutions server 104. Each such device can be pre-configured with a remote banking application (“app”) allowing a respective customer to use the device to communicate with the remote solutions server 104 to perform the remote banking or the customer can be directed to a remote banking website. The remote solutions server 104 facilitates remote banking wherein transactions can be completed using in-branch banking equipment. Additionally, the banking customer may schedule time with banking personnel using this application or website, wherein the meeting can take place at the same branch where the transaction will be completed. Although the present disclosure uses the term “branch” throughout in the traditional sense of a physical location for a bank or credit union staffed by people and where customers interact with human tellers and other personnel, it is to be understood that the present invention is also applicable to other types of “branches” such as automated “micro branches”, self-service kiosks, and automated teller machines.

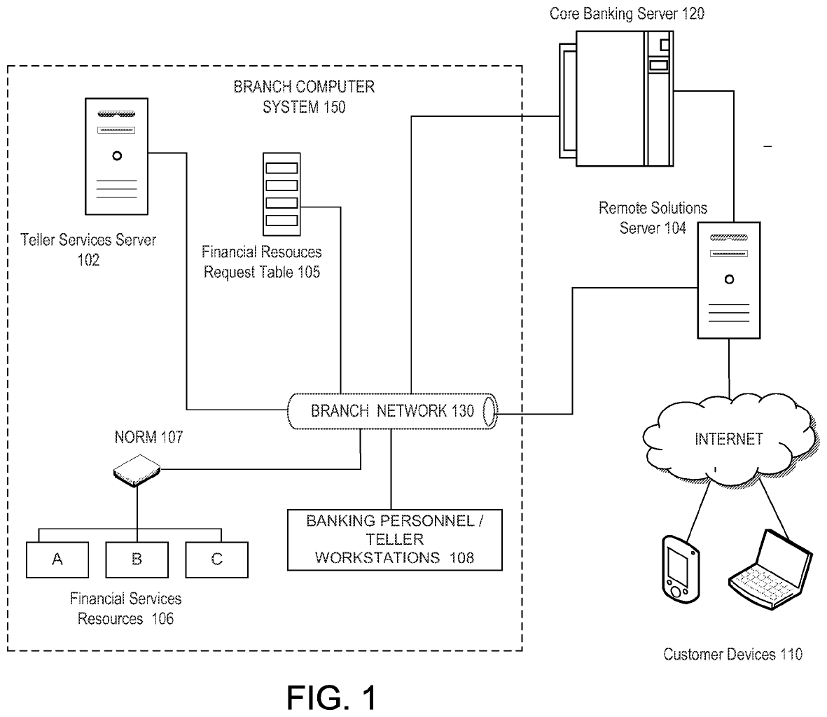

As shown, the branch computer system 150 includes a branch network 130 which allows the components of the branch computer system 150 to be interconnected and for secure communication to systems outside the branch. Within the branch, banking personnel/teller work stations 108 are connected via the branch network 130 to a teller services server 102 which includes various applications used by tellers and other banking personnel to perform their duties. The teller services server 102 is connected via the branch network 130 to the core banking server 120 which can be situated at a “central” location serving more than one such branch. In general, the core banking server 120 allows member branches to access applications and information from a centralized data center facilitating, for example, deposits to be posted substantially immediately so that a customer can thereafter withdraw the deposited money from any member branch. Additionally, the core banking server 120 can host a variety of banking applications to address the needs of banking customers and for internal banking administration, compliance, and so forth. It is to be understood that while only one banking branch is shown in FIG. 1, many such branches would exist and be interconnected to the core banking server 120.

As shown in FIG. 1, the branch computer system 150 further includes a plurality of financial services resources 106. Such financial services resources 106 can include, but are not limited to, various cash automation devices (e.g., cash dispensers, cash recyclers), check scanners, check writers, 2D bar code readers, coin dispensers, bill acceptors, pin pads, printers, card readers, scanners, signature pads, etc. Exemplary such financial services resources 106 include the Glory and Talaris lines of teller cash dispensers from Glory Global Solutions, Ltd., UK; the LS100 check scanner from CTS Electronics, Italy; various 2D bar code scanners from Honeywell Corporation, Morristown, N.J.; the Telequip line of coin dispensers from Crane Payment Solutions, Ontario, Canada; the VeriFone VX 805 pin pad and various card readers from VeriFone Holdings, Inc., San Jose, Calif.; and various printers by Seiko Epson Corporation, Japan. In general, each of the financial services resources 106 is a hardware device capable of being driven and/or controlled by one or more external computing device.

In the illustrated embodiment, one or more of the financial services resources 106 can be connected to a network outage and redundancy module (NORM) 106 which preferably is a “headless” device connected to the branch network 130. The NORM 107 includes a microcontroller such as a programmable logic controller (PLC) or application-specific integrated circuit (ASIC) having software embedded thereon or a microprocessor having software installed in a memory device coupled thereto, to increase security, availability, and/or connectivity. However, in other embodiments, one or more of the financial services resources 106 are used without the NORM 107. In that case, the financial services resources 106 can be directly connected to the branch network 130.

In the illustrated embodiment, the NORM 107 can drive, monitor, and store all activity for each of the financial services resources 106. In this embodiment, the NORM 107 can act as a universal driver operating with a variety of different financial services resources 106. In various embodiments, the NORM 107 may be configured to receive proprietary communication of the financial services resources 106 then convert the communications to a second communication that an enterprise system or enabled computing system is able to receive. In various examples the second communication may be a universal communication protocol. In the present embodiment, the NORM 107 can also provide redundancy by continually buffering all data passing through such that for a given time period any information can be recovered. In one example, the NORM 107 may only save information from the financial services resources 106 in response to the network status being non-operational. The NORM 107 may continually monitor the branch network 130 for adequate connectivity such that in the event of any disruption the NORM 107 may activate data storage functionality. The NORM 107 may also continually monitor the branch network 130 during an outage, such that communication can begin again as soon as the network is restored. Once the network connection is restored, the NORM 107 may forward the stored communications to a computing system on the branch network 130 to return the financial services resource 106 to normal operation while maintaining the integrity of all data. An exemplary device useable for the NORM 107 is disclosed in co-pending U.S. patent application Ser. No. 13/335,645 to Chen et al., entitled “Network Outage Redundancy Module”, filed on Dec. 22, 2011, which is incorporated by reference herein in its entirety.

Referring again to FIG. 1, the branch computer system 150 further includes a financial resources request table 105. Although the financial resources request table 105 is shown as a separate component, it is to be understood that the financial resources request table 105 could be implemented within another of the components shown, such as, for example the teller services server 102 or remote solutions server 104. Furthermore, it is to be understood that in a preferred embodiment, the financial resources request table 105 will be a relational database managed by a suitable relational database management system (RDBMS). In other embodiments, various other types of storage systems and file types could be used, such as a flat file, indexed file, arrays, linked lists, etc., to implement the financial resources request table 105. As will be described in greater detail, the financial resources request table 105 serves to store and track requests that have been made for in-bank devices and equipment. In the present embodiment, the financial resources request table 105 is indexed and records can be selected by certain key fields, such as teller id, customer id, transaction type, etc. Thus, requests from remote banking customers can be obtained and removed in any order. In an embodiment, requests originating from in-bank banking transactions can be removed from the front of the queue only or according to priority rules.

For the NORM 107, the necessary embedded software can be developed using any suitable computer language, but preferably the C language or assembly language, which is then compiled/assembled and stored in the microcontroller's ROM. For non-embedded software, such as the software executed on the remote solutions server 104 and the self-service stations, the software can be created using computer program code written in a variety of suitable programming languages, such as C, C++, C#, Visual Basic, and Java. It is to be understood that the software of the invention can be stored as machine-readable code on a non-transitory storage medium, and loaded into internal computer memory when needed, as is known in the art. Applications for the Apple iPhone and/or iPad can be developed using the Apple Developer Suite, including use of Xcode, Interface Builder, and iPhone Simulator development tools, or via custom programming in Objective C. For further information regarding programming for the Apple iPhone/iPad, see, Beginning iOS 5 Application Development, by Wei-Meng Lee (John Wiley & Sons, Inc.), ISBN 978-1-118-14425-1, which is incorporated herein by reference in its entirety. It is to be understood that where the device is other than the Apple iPhone/iPad, other programming techniques and tools can be used. For example, an application (“app”) for a smartphone or tablet computer utilizing the Android operating system can be programmed using an appropriate Android software development kit (SDK) which provides the tools and application program interfaces (API) for developing the application on the Android platform using the Java programming language.

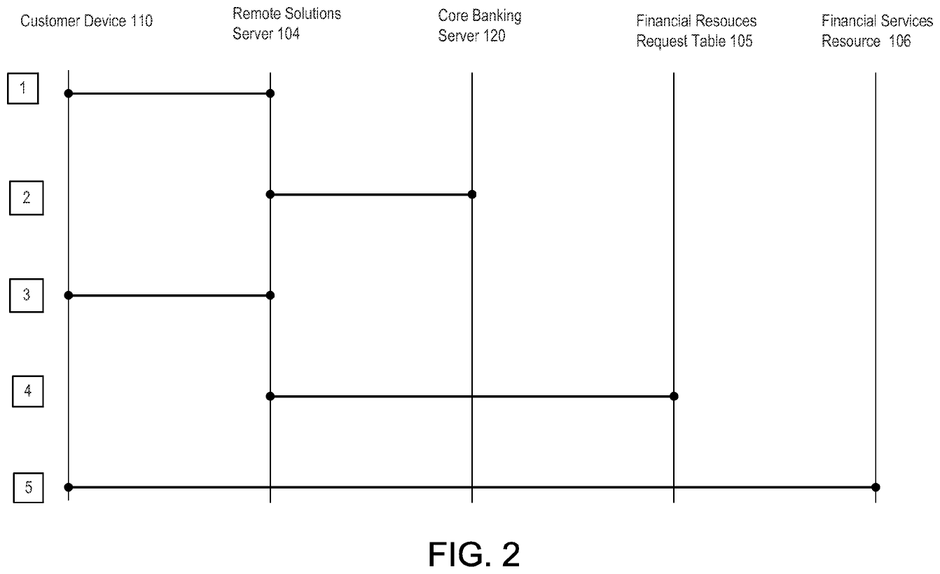

FIG. 2 illustrates use of the system of FIG. 1 for a transaction initiated using a remote banking application and completed at the branch.

In step 1, a customer device 110 connects with the remote solutions server 104 to initiate a remote banking transaction. For example, the customer device 110 could be a smartphone (e.g., Apple iPhone 5) with Internet access having an application running on the device allowing for remote banking or the device 110 could browse a web site set up by the bank to allow remote banking. In either case, the remote solutions server 104 would require authentication of the customer such as by providing a user id and password. After being authenticated, the customer would use the remote banking transaction to begin one or more banking transaction. For example, the customer might initiate a request to withdraw $5,500 from his savings account. Additionally, the customer might request a meeting with his personal banker regarding a line of credit or loan.

In step 2, the remote solutions server 104 connects with the core banking server 120. The core banking server 120 includes the business logic behind all transactions performed within the financial institution. At this point, in the example, the core banking server 120 would access the customer's savings account to determine whether there are sufficient funds. If the funds are available, the core processor would deduct $5,500 from the customer's saving's account. In an embodiment, the transaction would be marked as “pending” subject to the actual cash being dispensed. Once the actual withdrawal happens, the transaction would then be marked as “posted”. If the withdrawal is not later completed, the transaction would be “cancelled” and the $5,500 credited back to the savings account. In other embodiments, the transaction would be marked as “posted” immediately subject to being “reversed” or “cancelled” if the withdrawal is not done successfully within a predetermined time period.

In step 3, the remote solutions server 104 generates a unique identification. The unique identification can be accomplished by a 2D bar code or other smart identifier provided by the remote solutions server 104. For example, the remote server 104 might send graphical data to the customer device 110 which is displayed on the customer device 110 as a 2D bar code. The 2D bar code could also preferably be printed or saved. There are other forms of unique identification available and supported by the remote solutions server 104, such as, for example, NFC, RFID, physical pin pads, biometrics, etc. For the purpose of the present invention, scanner technology will be used as an example for all of the aforementioned types of identification.

In step 4, the remote solutions server 104 connects with the financial resources request table 105 to store a request for the particular financial resource 104. In the present embodiment, the financial resources request table 105 is contained within a particular branch. Accordingly, the customer would have to select a particular branch for the withdrawal. In other embodiments, the financial resources request table 104 can be provided at a “central” location, such as within the remote solutions server 104 connected to each of the branches. In that case, the customer could arrive at any branch and complete a transaction. Additionally, the remote solutions server 104 would check for available times for the requested meeting with a personal banker. After receiving from the customer a selected meeting time, the remote solutions server 104 can update a calendar for a personal banker at the selected branch.

In step 5, the customer arrives at the selected branch. At the branch, the customer scans the provided unique identifier at a designated kiosk or customer self-service banking center. The kiosk or customer self-service banking center can be equipped with one or more computer system and scanning device having logic to complete the transaction. Once the unique identifier is scanned, the request for the customer's transaction is retrieved from the financial resources request table 105, and if matched with the token information, the transaction is completed using an available financial services resource 106, such as an automated cash dispenser. In the example, the automated cash dispenser would be directed via the NORM 107 to dispense $5,500 to the customer. The transaction would then be marked as “completed” at the core banking server 120. After the withdrawal, the customer could then meet with the designated personal banker to discuss a line of credit or loan. It is to be understood, that in certain cases additional identification would be necessary and not all banking transactions could be performed using the disclosed methods.

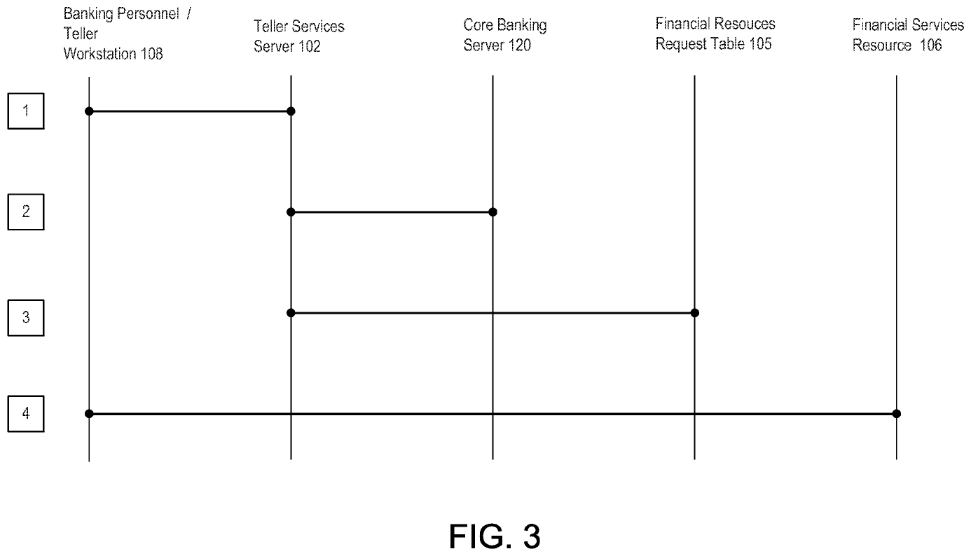

FIG. 3 illustrates use of the system for a transaction initiated using a teller application in a branch and completed at the branch according to an embodiment of the present invention.

In step 1, banking personnel such as a teller or other authorized employee initiate a banking transaction by connecting the banking personnel/teller workstation 108 with the teller services server 102.

In step 2, the teller services server 102 connects with the core banking server 102 to perform the transaction.

In step 3, the teller services server 102 connects with the financial services request table 105. The requests from the tellers/other banking personnel (hereinafter “teller requests”) can be treated differently from requests from remote customers in that there will generally be more urgency for a teller to complete a transaction. (Remote customers can wait in a line at the branch for the next available financial services resource 106). As such, the teller requests can be placed into a first-in, first-out (FIFO) queue. Because, at any given time, there may be more requests to use a particular financial services resource 106 than there are available financial services resources 106 of the type requested (e.g., a cash dispenser), the requester might have to wait for one to become available. As each teller request is sent to the financial resources request table 105, the request is added to the back of a queue for the requested resource. As a financial services resource 106 becomes available, the request at the front of the queue is assigned to the available financial services resource 106 (and then deleted from the queue). In a branch, there may be many of the same type of financial services resource 106 (e.g., five cash dispensers). As such there can be a single queue for a group of similar financial services resources 106. Although the present discussion involves a “FIFO” queue, it is to be understood that other suitable types of queues or other ordered sets may be used. For example, a priority queue may be used such that more valued or urgent resource requests are assigned higher priorities.

In step 4, the teller or other banking personnel accesses an identified financial resource 106. For example, the financial resources can have an identifier such as “cash recycler 6” which is indicated at the teller station as being available.

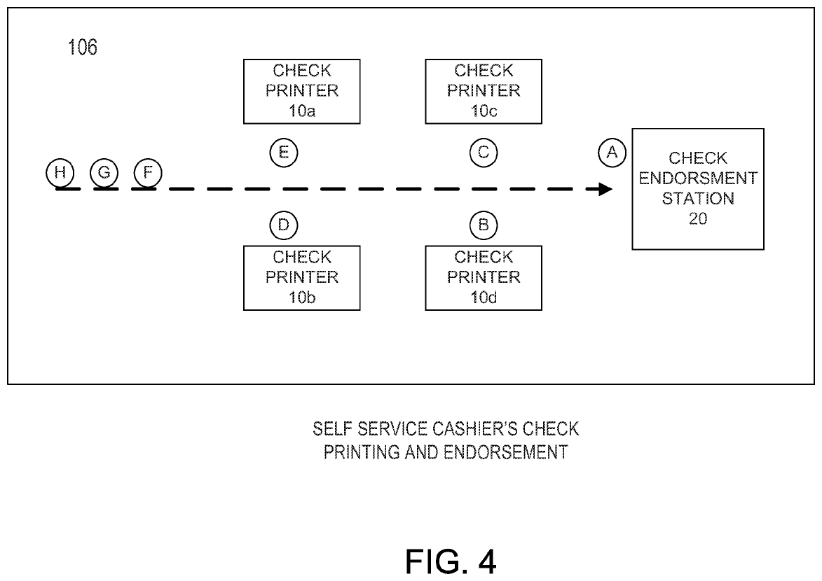

FIG. 4 illustrates an exemplary self-service arrangement for cashier's check printing and endorsement, used in conjunction with the present invention according to an embodiment of the present invention. As shown, a single-line, multiserver waiting line includes customers A to H forming a line where four check printers 10a-d are available to serve the customers. Each of the check printers 10a-d include a self-service arrangement wherein a customer can complete a banking transaction involving printing a cashier's check in the branch. In an embodiment, the customers have already initiated a banking transaction to withdraw money from an account using a remote banking application. In other embodiments, customers can perform the entire banking transaction in the branch. In an embodiment, each of the check printers 10a-d further include a computer terminal for completing the transaction entirely in the bank. As shown, customer A is at the front of the line and has already printed a cashier's check. However, the cashier's check requires approval and endorsement from an authorized banking employee. At the check endorsement station 20, customer A presents his printed check which is then endorsed by the authorized banking employee. If customer A is not ready when customer B finishes printing his or her check, customer B will wait in line after customer A, and so forth. In still other embodiments, the entire check printing and endorsement process can be automated without the necessity of endorsement of the checks by a human. In this case, the endorsement station 20 would not be used, and the endorsement would be done at the check printers 10a-10d. Additionally, it is to be appreciated that other waiting lines can be implemented, such as a multi-line, multiserver waiting line.

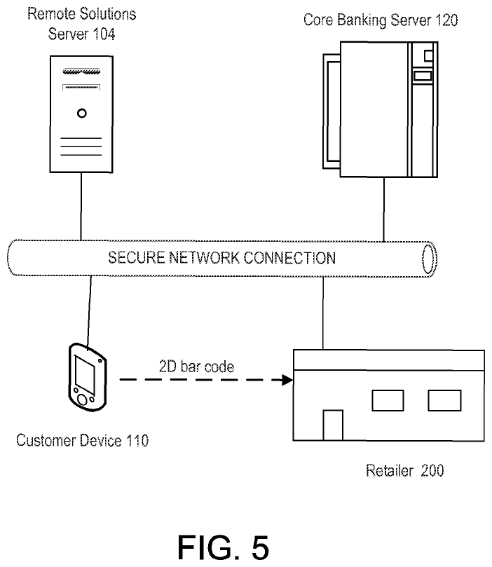

FIG. 5 illustrates an exemplary ecommerce system in which a financial transaction is initiated using a remote banking application and completed at a retail location, according to another embodiment of the present invention. As previously discussed, a customer using a customer device 110 can initiate a banking transaction by connecting the customer device 110 to the remote solutions server 104 which, in turn, can interact with the core banking server 120 to move funds. However, instead of completing the banking transaction using a financial services resource 106 within a branch, the customer may instead wish to “complete” the transaction by purchasing a good or service. As depicted in FIG. 5, the customer device includes a unique identifier such as a 2D bar code which can be presented to a retailer 200. The retailer 200 is equipped with a scanner and software which allows the identifier to be authenticated by accessing the remote solutions server 104. After the transaction is completed (e.g., the customer purchases an item), the retailer 200 is electronically provided with credit for the amount of the sale. It is to be understood that FIG. 5 is a simplified version of an actual ecommerce solution, and there may be other financial institutions involved (such as a merchant bank) and various intermediaries to effect settling of funds. It is to be understood that this embodiment could be used with or without reliance on existing credit or debit card networks.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. (canceled)

2. A method for utilizing one of a plurality of hardware devices all of which are capable of completing transactions, the method comprising:
a) at a computer server, communicating with a first computing device to establish secure transaction details relating to a secure transaction, the secure transaction requiring access to one of the plurality of hardware devices, wherein the communicating does not identify any particular individual hardware device;
b) after step a) and at the computer server, generating an authentication token usable to complete the secure transaction at any one of the plurality of hardware devices, the authentication token containing token information;
c) after step b) and at the computer server,
i) storing the secure transaction details for the secure transaction in a resource request database located at a central location, the resource request database at the central location being in electronic data communication with all of the plurality of hardware devices, and
ii) transmitting the authentication token to the first computing device;
d) after step c) and at the first computing device, receiving the authentication token and creating a machine-readable representation of the authentication token separate from the first computing device;
e) after step d) and at a first hardware device of the plurality of hardware devices, reading the machine-readable representation of the authentication token that is separate from the first computing device;
f) after step e) and at the first hardware device, initiating a first communication for the first hardware device concerning the secure transaction by requesting and receiving the secure transaction details from the resource request database;
g) after step f) and at the first hardware device, verifying the authentication token by matching the token information against the received secure transaction details; and
h) after step g) and at the first hardware device, using the secure transaction details to complete the secure transaction.

3. The method of claim 2, wherein the machine-readable representation of the authentication token that is separate from the first computing device is a 2D bar code read by a scanner.

4. The method of claim 3, wherein the 2D bar code is printed on paper.

5. The method of claim 2, further comprising:
i) after completing the secure transaction and at the first hardware device, providing a completion report to the computer server.

6. The method of claim 2, wherein the computer server records the secure transaction as pending after step a) and records the secure transaction as posted after step i).

7. The method of claim 2, wherein the computer server records the secure transaction as posted after step a), further wherein the computer server contains programming that records the secure transaction as reversed when a completion report is not received from any of the plurality of hardware devices within a predetermined time period.

8. The method of claim 2, wherein a first subset of the plurality of hardware devices are located in a first banking branch building and a second subset of the plurality of hardware devices are located in a second banking branch building.

9. The method of claim 8, wherein the plurality of hardware devices are financial output devices selected from a set of devices consisting of cash dispensers, coin dispensers, and check writers, and further wherein completing the secure transaction results in outputting cash, coins, or printed checks.

10. The method of claim 2, wherein a first subset of the plurality of hardware devices are located in a first building and a second subset of the plurality of hardware devices are located in a second building.

11. The method of claim 2, wherein the first computing device is one of a smartphone, a tablet computer, and a laptop.

12. A method for utilizing one of a plurality of hardware devices all of which are capable of completing transactions, the method comprising:
a) at a computer server, communicating with a first computing device to establish secure transaction details relating to a secure transaction, the secure transaction requiring access to one of the plurality of hardware devices, wherein the communicating does not identify any particular individual hardware device;
b) after step a) and at the computer server, generating an authentication token usable to complete the secure transaction at any one of the plurality of hardware devices, the authentication token containing token information;
c) after step b) and at the computer server,
i) storing the secure transaction details for the secure transaction in a resource request database located at a central location, the resource request database at the central location being in electronic data communication with all of the plurality of hardware devices, and
ii) transmitting the authentication token to the first computing device;
d) after step c) and at a first hardware device of the plurality of hardware devices, reading a machine-readable representation comprising a 2D bar code from a mobile device;
e) after step d) and at the first hardware device, initiating a first communication for the first hardware device concerning the secure transaction by requesting and receiving the secure transaction details from the resource request database;
f) after step e) and at the first hardware device, verifying the authentication token by matching the token information against the received secure transaction details; and
g) after step f) and at the first hardware device, using the secure transaction details to complete the secure transaction.

13. The method of claim 12, further comprising:
i) after completing the secure transaction and at the first hardware device, providing a completion report to the computer server.

14. The method of claim 12, wherein the computer server records the secure transaction as pending after step a) and records the secure transaction as posted after step i).

15. The method of claim 12, wherein the computer server records the secure transaction as posted after step a), further wherein the computer server contains programming that records the secure transaction as reversed when a completion report is not received from any of the plurality of hardware devices within a predetermined time period.

16. The method of claim 12, wherein a first subset of the plurality of hardware devices are located in a first banking branch building and a second subset of the plurality of hardware devices are located in a second banking branch building.

17. The method of claim 16, wherein the plurality of hardware devices are financial output devices selected from a set of devices consisting of cash dispensers, coin dispensers, and check writers, and further wherein completing the secure transaction results in outputting cash, coins, or printed checks.

18. The method of claim 12, wherein a first subset of the plurality of hardware devices are located in a first building and a second subset of the plurality of hardware devices are located in a second building.

19. The method of claim 12, wherein the first computing device is one of a smartphone, a tablet computer, and a laptop.

20. A method for utilizing one of a plurality of hardware devices all of which are capable of completing transactions, the method comprising:
a) at a computer server, communicating with a first computing device to establish secure transaction details relating to a secure transaction, the secure transaction requiring access to one of the plurality of hardware devices, wherein the communicating does not identify any particular individual hardware device;
b) after step a) and at the computer server, generating an authentication token usable to complete the secure transaction at any one of the plurality of hardware devices, the authentication token containing token information;
c) after step b) and at the computer server,
i) storing the secure transaction details for the secure transaction in a resource request database located at a central location, the resource request database at the central location being in electronic data communication with all of the plurality of hardware devices, and
ii) transmitting the authentication token to the first computing device;
d) after step c) and at the first computing device, receiving the authentication token;
e) after step d) and at a first hardware device of the plurality of hardware devices, reading the authentication token from the first computing device;
f) after step e) and at the first hardware device, initiating a first communication for the first hardware device concerning the secure transaction by requesting and receiving the secure transaction details from the resource request database;
g) after step f) and at the first hardware device, verifying the authentication token by matching the token information against the received secure transaction details; and
h) after step g) and at the first hardware device, using the secure transaction details to complete the secure transaction.

21. The method of claim 20, wherein the plurality of hardware devices are financial output devices selected from a set of devices consisting of cash dispensers, coin dispensers, and check writers, and further wherein completing the secure transaction results in outputting cash, coins, or printed checks.
